(19) United States
(12) Patent Application Publication
(10) Pub. No.: US 2007/0191968 A1
(43) Pub. Date: Aug. 16, 2007

(54) System and Method For Adaptive Modification Of a Task Performance System

(75) Inventors: Vinay Sikka, Westland, MI (US); Ananthakrishnan Surianarayanan, Lansdale, PA (US)

Correspondence Address: EDWARD ETKIN, ESQ., Law Office of Edward Etkin, PC, 228 West End Avenue, Suite A, Brooklyn, NY, 11235, US

(73) Assignee: PATHWAY TECHNOLOGIES, INC., Lansdale, PA (US)

(21) Appl. No.: 11/694,688

(22) Filed: Mar. 30, 2007

Related U.S. Application Data
(63) Continuation of application No. 10/911,161, filed on Aug. 2, 2004.
(60) Provisional application No. 60/492,771, filed on Aug. 2, 2003.
(60) Provisional application No. 60/787,573, filed on Mar. 30, 2006.

(51) Int. Cl. G05B 15/00

(52) U.S. Cl. 700/1

(57) ABSTRACT

The system and method of the present invention enable a task performance system made up from two or more components to be readily modified, in response to one or more predetermined criteria, to adapt to new functional and/or operational requirements. This modification may be automatic manual, or a combination thereof. Likewise, the predetermined criteria may range from failure of one or more task performance system components, to an instruction received from an authorized operator. The inventive system and method accomplish these objectives by causing one or more of the components of the task performance system to change functionality (e.g., to change the functions being performed by one or more components, to add one or more functions to one or more components, etc.) to implement the desired modification of the entire task performance system.

### CROSS REFERENCE TO RELATED APPLICATIONS

The present patent application claims priority from, and is the continuation of, the commonly assigned copending U.S. patent application Ser. No. 10/911,161, entitled “System and Method for Rapid Design, Prototyping, and Implementation of Distributed Scalable Architecture for Task Control and Automation”>filed on Aug. 2, 2004>which in turn claims priority from the commonly assigned U.S. Provisional Patent Application Ser. No. 60/492,771, entitled “System and Method for Rapid Design, Prototyping, and to Implementation of Distributed Scalable Architecture for Task Control and Automation”, filed on Aug. 2, 2003; the present patent application also claims priority from the commonly assigned U.S. Provisional Patent Application, Ser. No. 60/787,573, entitled “SYSTEM AND METHOD FOR ADAPTIVE MODIFICATION OF A TASK PERFORMANCE SYSTEM”, filed Mar. 30, 2006.

### FIELD OF THE INVENTION

The present invention relates generally to a data processing system and method for enabling modification of scalable distributed systems that perform various tasks, and more particularly to a flexible data processing system and method that enable, in response to one or more predetermined criteria, adaptive modification of task performance systems, including, but not limited to, industrial process control systems, other embedded systems, multi-component electrical, electronic, or electromechanical devices, and distributed computer systems.

### BACKGROUND OF THE INVENTION

Virtually all electronic and electromechanical devices and systems, whether in military, law enforcement, industrial, commercial, or consumer use, are made up of a hierarchy of electronic sub-components, ranging from integrated circuit chips (such as digital signal processing (DSP) chips, central processing units (OPUs), etc.) to chipsets (video processing, input/output (I/O) control, etc.), to entire electronic control units (ECUs) commonly used in embedded systems, industrial control applications, and the like).

While components of traditional computer systems are designed with significant flexibility in mind because most such systems are utilized in conjunction with complex software operating systems and application programs that essentially determine the functionality of the system components, thus flexibility comes with a price-reliability. Thus, in many commercial, industrial and military applications, embedded systems (for example that utilize electronic control units (ECUs), or equivalents) are very popular due to their reliability, even if flexibility of conventional computer hardware/software systems is sacrificed.

However, as applications for data processing systems in all fields of endeavor have grown more and more complex and demanding, there has been a great need for finding a middle ground between flexibility of conventional computer systems and reliability of embedded systems. The most significant push in this regard has been toward changing the way in which embedded systems, especially those in complex industrial applications, are designed and configured.

Traditionally, the process of design, prototyping and implementation of complex industrial applications (such as manufacturing process control, multi-component devices and other systems or devices), has been an extremely difficult, costly and time consuming task. Typically, this process involved a long iterative, and often empirical, process, of formulating the requirements of the desired system, conceptually planning the system, developing a prototype, writing programs or other code necessary for implementation, testing the implemented prototype and then repeating many of the steps, in most cases including the arduous and frustrating coding of new programs, even when minor changes to the prototype are necessary. In cases of more serious issues the entire system is often re-designed further consuming a great deal of time and resources. This trial and error approach of system and device design has been a challenge for engineers and designers for years.

However, as data processing systems came into increased use in the last several decades, attempts have been made to automate and simplify at least some of the steps involved in system design, prototyping, and implementation, both for design of new systems and for modification, re-engineering and improvement of existing industrial systems. Thus, as data processing (i.e. computer) systems have gained increased utilization in the field of system and device design, a great deal of effort was directed toward providing engineers and system designers with powerful software tools that simplify the difficult goal of designing and modeling a system (e.g., industrial, computer, process control, etc.) or an apparatus (e.g., automobile exhaust system, engine, motor, etc.) in a software environment. The ultimate goal of these tools was to enable the user (e.g., the engineer) to design a software model of the desired system, simulate the model to ensure proper system operation, and hopefully assist the user in implementing the modeled system in real-world devices.

Nevertheless, even with the aid of currently available powerful software tools, prototyping of a complex system or apparatus which generally requires a distributed architecture for its various operational parameters (such as an industrial process control application), it is a difficult and time consuming process with at least the following steps that must be performed by the user as part of the design to implementation cycle:

1) Design the desired target system functionality:

2) Break down the target system manually into distributed target components often requiring slight modification in design, model each component and their connections separately to correspond to a real-world target device or system, and assign a portion of the desired functionality to each component, and establish connections between appropriate components;

3) Write appropriate software code to cause each component to perform their assigned functionality as well as to ensure proper communication and data interchange between various components

3) Simulate the operation of the system, testing and monitoring one component at a time; and

4) Manage the system (i.e. issue commands such as start, stop, record progress or status), one component at a time.

5) If problems occur, repeat one or more of the previous steps until the target system performs acceptably,

Because the key actions for alt of the above tasks must be performed manually by the user, even with the assistance of the most powerful currently available design tools, the design-to-implementation cycle in continuous product development industries (such as automotive and aerospace industries), remains undesirably long. In additions changes to the system architecture or to system components during the prototyping process must be manually propagated through the entire system, thus resulting in a further significant delay and expense. Furthermore, the most frustrating and difficult tasks for the user of previously known system design software tools—the second and third steps shown above—are still an ever-present requirement. Thus, the user must still engage in the manual and time-intensive partitioning of the designed system into multiple components corresponding to various real-world hardware systems and writing a great deal of code each time a change to any aspect of the system must be made (e.g., moving an element of a model to a different partition to relieve the toad on a target component), but now utilizing an attractive graphical user interface to do so, And with many design systems after the design and prototype modeling process is complete, appropriate software code must be manually generated for each target system component.

The above issues are due at least in part to the fact that the great deal of the advancements in the system design and modeling toots have been directed to improvements of preliminary system design capabilities, for example to provide users with innovative and easy to use graphical design tools, to enable visual concept-to-design model development, and to otherwise shorten the concept-to-design cycles, to enable improved computerized design simulation. Others directed their research and development to offering improvements and innovations in hardware target components, resulting in relatively inexpensive and powerful embedded system target components that may be utilized to emulate real-world physical components or that may be used as production target components themselves. Accordingly, the area between the two has been largely neglected or ignored. Finally, the majority of existing design software tools are generally limited to utilization in the field of embedded system design and cannot be readily used in other forms of distributed task performance systems.

However, a revolutionary scalable technique for simplifying and accelerating the process of prototyping real-world simulation, and implementation of virtually any task performance system or device, thereby dramatically reducing the design-to-implementation cycle time and expense to a fraction of any previously known technique, was disclosed in the commonly assigned co-pending U.S. patent application entitled “SYSTEM AND METHOD FOR RAPID DESIGN, PROTOTYPING, AND IMPLEMENTATION OF DISTRIBUTED SCALABLE ARCHITECTURE FOR TASK CONTROL AND AUTOMATION”, which is hereby incorporated herein by reference in its entirety. This patent application (hereinafter “Model Partition Application”), disclosed an inventive system that includes a development system that provides a user, with visual tools to interactively and dynamically partition a previously designed visual system model of the task performance system or device, and then interactively (or automatically) assign the partitions to corresponding selectable target components, to produce a prototyped system ready for conversion to executable form suitable for implementation. The system and method of the Model Partition Application can also be readily used to automatically generate any instruction sets (egg programs, drivers, or modules) that are necessary for implementing the prototyped task performance system in actual target components of one or more emulation and/or production target systems.

A novel automatic executable program code generation process that can be advantageously utilized was also provided by the Model Partition Application.

While the system and method of the Model Partition Application were advantageous in many ways, they did not readily address one important goal in use of reliable (embedded) task performance systems—how can an embedded system respond to changes in is operating conditions, changes in the environment, changes in task requirements, operator error, and hardware/software failure. In essence, the above-described novel prototyping system did not address how to reconfigure or modify the system in the field, during its operation, rather than during the prototyping process to respond to the above challenges.

It would thus be desirable to provide a system and method for adaptively modifying a task performance system in response to one or more criteria. It would also be desirable to provide a system and method for making such modification automatically, semi-automatically and/or under user intervention.

### BRIEF DESCRIPTION OF THE DRAWINGS

In the drawings, wherein like reference characters denote corresponding or similar elements throughout the various figures:

FIG. 1 shows a block diagram of an exemplary embodiment of the inventive adaptive task performance modification (hereinafter “ATPM”) system implemented in a task performance system;

FIG. 2 shows a diagrams representative of an exemplary embodiment of a protocol for guiding operation of the ATPM system of FIG. 1;

FIG. 3 shows a process flow diagram representative of an exemplary embodiment of the process of modification of the task performance system of FIG. 1; and

FIG. 4 shows a process flow diagram representative of an exemplary embodiment of the process of operation of, and triggers for modification of, the task performance system of FIG. 1.

### SUMMARY OF THE INVENTION

The system and method of the present invention enable a task performance system made up from two or more components to be readily modified, in response to one or more predetermined criteria, to adapt to new functional and/or operational requirements. This modification may be automatic manual, or a combination thereof. Likewise, the predetermined criteria may range from failure of one or more task performance system components, to an instruction received from an authorized operator. The inventive system and method accomplish these objectives by causing one or more of the components of the task performance system to change functionality (e.g., to change the functions being performed by one or more components, to add one or more functions to one or more components, etc.) to implement the desired modification of the entire task performance system. In addition, the inventive system and method are independent of the tools used for designing and modeling the task performance system to which they are applied. Thus, the inventive system and method can be readily applied to any task performance system that may be represented in an abstract functional form, regardless of how the task performance system has been designed and/or implemented.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED E EMBODIMENTS

The system and method of the present invention provide a number of advantageous novel features to task performance systems having two or more configurable components enabling the task performance system to be modified on an as-desired or as-needed basis (automatically, manually or as a combination thereof) whether in response to a command (or commands) and/or in response to one or more predetermined conditions. The novel system and method can work with any task performance system designed with a partitioning approach, where the original system design is partitioned into functions and/or function groups, and then assigned to various physical system components. While the techniques described in the above-incorporated Model Partition Application are most advantageous when used in conjunction with the system and method of the present invention it should be noted that as a matter of design choice, the system and method of the present invention may be readily utilized with any other partitioning approach, whether automatic, manual, or a combination of the two.

Furthermore, the system and method of the present invention are independent of the tools used for designing and modeling the task performance system to which they are applied. Thus, the inventive system and method can be readily applied to any task performance system that may be represented in an abstract functional form, regardless of how the task performance system has been designed and/or implemented.

In essence, the inventive adaptive task performance modification (hereinafter “ATPM”) system, enables the main task performance system to be readily modified, in response to one or more predetermined criteria, to adapt to new functional and/or operational requirements. This modification may be automatic, manual, or a combination thereof. Likewise, the predetermined criteria may range from failure of one or more task performance system components, to an instruction received from an authorized operator. The novel ATPM system accomplishes its objectives by causing one or more of the components of the task performance system to change functionality (e.g., to change the functions being performed by one or more components, to add one or more functions to one or more components, etc.) to implement the desired modification of the entire task performance system.

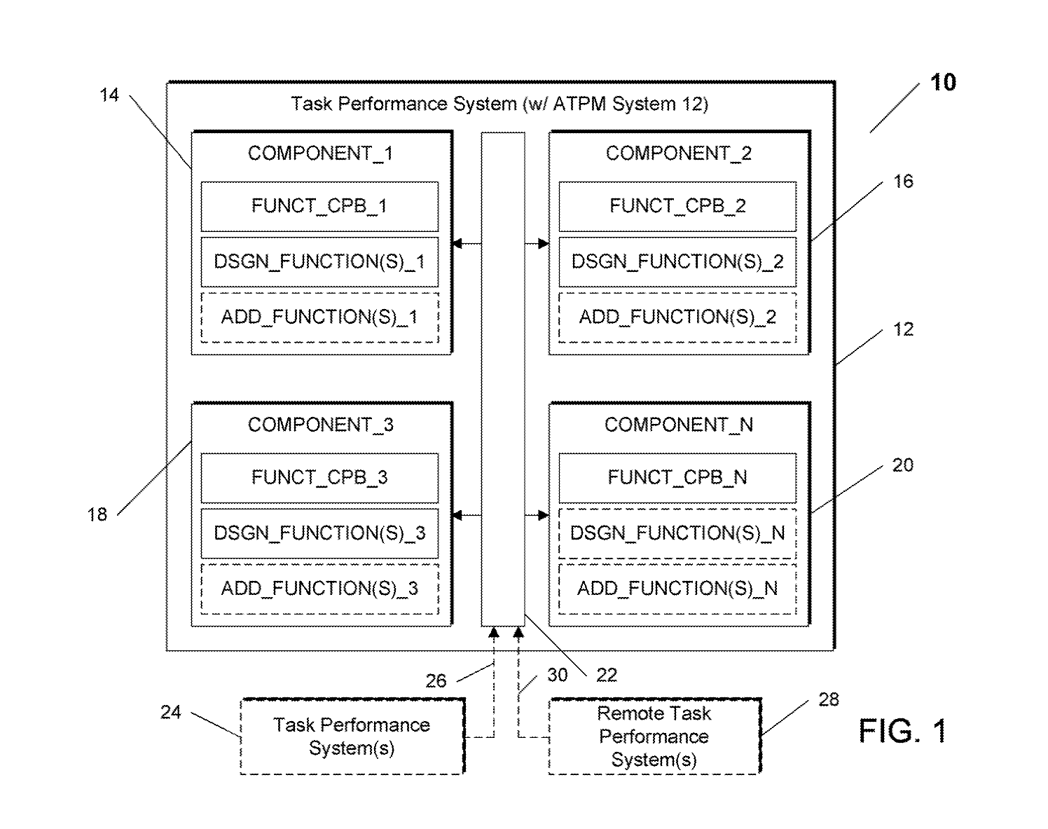

In summary, the inventive ATPM system, is representative of specific novel functionality that may be added to any eligible task performance system, which is preferably partionable and which includes at least one configurable component that has at least one of the following characteristics: capable of multiple selectable functions, is field programmable to perform a wide range of functions, has multiple modes of operation, has field reconfigurable parameters and/or operating characteristics, and so on. The various types of system components with such capabilities are discussed in greater detail below in connection with FIG. 1. When a specific predetermined criteria or criterion for modification of the task performance system is met, the ATPM system causes one or more of the configurable system components to change one or more of its characteristics as may be necessary to achieve the desired system modification.

This may be accomplished using a number of different approaches, depending on the nature and complexity of desired system modification. For example, a simple system modification in response to an increased computational load on a task performance system, may modify operating characteristics of one or more task performance system components to cause the components to operate under a higher “load”, making more computational resources available to the system. On the other hand, a more complex modification that requires the task performance system to exhibit entirely new features (for example requiring embedded control units responsible for temperature monitoring in manufacturing facility to determine whether window louvers should be opened to increase airflow in response to a rapid spike in temperature, or in upgrading the system to include new features), or that radically shifts tasks between components (for example, causing the programmable system components responsible for fire alarm in a building, to take over the functionality of a failed intrusion/surveillance security system) may require reconfiguration of the entire task performance system, for example by re-partitioning the system.

The above-incorporated Model Partition Application discussed the principles and benefits of using partitioning (and subsequent automatic code generation) to rapidly prototype and implement virtually any task performance system. The Model Partition Application also disclosed that during the prototyping and testing process, a partitioned system can be adjusted and modified as necessary by repartitioning it, and by re-assigning certain partitions to different target system components.

In one embodiment of the present invention, the novel ATPM system utilizes the advantageous partitioning techniques such as disclosed in the Model Partition Application (or equivalent thereof), to repartition at least a portion of the task performance system and then implement the necessary instruction generation to ensure that the system components in the new and/or modified partitions behave as desired. In another embodiment of the invention, the novel ATPM system partitions the task performance system (which has not been previously formally partitioned) in response to one or more criteria being met. In yet another embodiment of the invention, the novel ATPM system enables an operator to either manually perform the desired partition modification, re-partitioning, and/or new partitioning, or to guide, supervise and/or modify the results of the ATPM system operation, when such processes are automated. In an alternate embodiment of the inventions the ATPM system may be provided with criteria for returning the task performance system to its previous state (or to make additional modifications) when the criteria are met.

Referring now to FIG. 1, a first exemplary embodiment of a task performance system 10, incorporating a novel ATPM system 12 is shown. The ATPM system 12 may either be embodied in a specific component of the system 10, or may have its functionality spread among one or more components of the system 10 that have their own core functions.

The system 10 includes at least two system components (four are shown by way of example in FIG. 1), preferably capable of having at least one of their characteristics changed without necessarily being removed from or disconnected from the system 10.

Preferably, such system 10 components (shown as COMPONENT_{—}1 to COMPONENT_N in FIG. 1) may include, but are not limited to, one or more of the following (alone or in combination): various types of smart devices (including data collection devices such as sensors), field programmable gate arrays (FPGAs), complex programmable logic devices (CPLDs), embedded control units (ECU), digital signal processors (DSPs), software configurable microprocessors, various configurable logic devices (EPROM, EEPROM, etc.), and equivalents thereof. Each COMPONENT includes such physical characteristics (size, I/O connections, power requirements, support device requirements (e.g., memory), etc.) as are appropriate to its type.

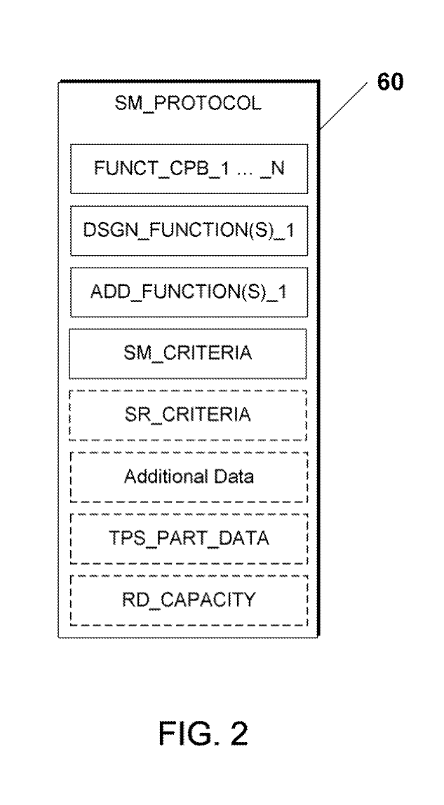

In one embodiment of the invention, as described below in connection with FIGS. 2-4, the ATPM system 12 may operate on the principle of a hardware abstraction layer (HAL). This embodiment is particularly advantageous if the task performance system 10 is an embedded system. Utilization of HAL methodology ensures portability of a partitioned task performance system 10 across multiple components, and facilitates field re-partitioning and new code generation without concern for compatibility of the newly repartitioned (and recoded) system with every single system component.

The necessary changes and/or modifications in characteristics (settings, parameters, functionality, etc.) are accomplished in a manner appropriate for the type of the COMPONENT_1 to _N (e.g., if a COMPONENT is an FPGA, this may be accomplished using hardware description language (HDL) to describe the desired effects, then using electronic design automation tools to create a netlist, and then fitting the netlist to the COMPONENT (for example, by using trace-and-route or equivalent techniques). Of course the changes may then be simulated and/or verified, as desired.

Each COMPONENT 14-20, preferably has a set of functional capabilities (FUNCT_CPB_1 to _N) representative of the extent and list of various functions that the COMPONENT is capable of performing, as well as the ranges and boundaries of its connectivity, configurability (setting ranges, extent of operating modes, sensitivity, environmental tolerance, I/O options, etc.), processing power, and other operational characteristics. Optionally, the FUNCT_CPB may include business characteristics, such as COMPONENT cost, availability, etc. Of course the FUNCT_CPB varies depending on the type of COMPONENT in question. For example, for FPGAs, rather than a list of specific functions, the FUNCT_CPB may include the characteristics of the FPGA which define the limitations of what functions it can be programmed to perform. Essentially, the FUNCT_CPB of each COMPONENT represents the furl spectrum of options available to the ATPM system 12, when modifying the task performance system 10. The FUNCT_GPB of each COMPONENT may be simply inherent in the COMPONENT itself, or optionally may be included as data available to, and usable by the ATPM system 12 (to facilitate system 10 modification).

Each COMPONENT 14-20, also preferably includes at least one designated function (DSGN_FUNCTION(S)_1 to _N) representative of the actual functions assigned to the COMPONENT when the system 10 was constructed (or after the last modification by the ATPM system 12), as well as other COMPONENT configuration and setting information necessary for the operation of the system 10. Optionally, one or more COMPONENTS may not have DSGN_FUNCT(S), and in essence be held in reserve by the system 10, in case the COMPONENT(S) become(s) needed by the ATPM system 12. By way of example, the DSGN_FUNCTION(S)_N is shown as optional in COMPONENT_N 20.

In one embodiment of the invention, by way of example, one or more of the COMPONENTs may also include one or more specific predetermined additional functions (ADD_FUNCTION(S)) that the COMPONENT is capable of performing if instructed by the ATPM system 12. If present, The ADD_FUNCTION(S) of a COMPONENT may be simply inherent in the COMPONENT itself, or optionally may be included as data available to, and usable by the ATPM system 12 (to facilitate system modification). Having one or more predetermined ADD_FUNCTION(S) is of course more appropriate when a COMPONENT has limited programmability and field modification capabilities. Thus, an ECU or a CPLD COMPONENT may have a list of such possible ADD_FUNCTION(S), while a FPGA-based COMPONENT does not require a list of ADD_FUNCTION(S) due to the great number of possibilities offered by its freely programmable nature.

In addition to the specific device or devices on which it is based, each COMPONENT may be programmed and configured as a matter of design choice. For example, a COMPONENT can be a smart device/sensor which includes at least the following advantages. For example, a COMPONENT may be able to make intelligent decisions based on input signals, can be programmed to make different decisions (and then reprogrammed if the system 10 is modified), can send/receive/store data and enhance the value of information therein. A COMPONENT can also include other “smart” features and characteristics, such as self-calibration, ease of setup and use, multiple standard support. Moreover, a COMPONENT can advantageously be configured as a self-defining device with a stored electronic data sheet (EDS) containing FUNCT_CPB, DSCN_FUNCTION(S), and possibly ADD_FUNCTION(S). The advantages of self-defining devices include, but are not limited to.
Reduced configuration time—no manual data entry
Calibration information may be part of EDS—leads to better accuracy
Self-Calibration: if COMPONENT is, or includes a sensor, it can adapt to changes in sensed target (environment, etc.)
Can contain data describing the type of data available from the device
Can run self-diagnostics based on stored parameters at system level
Can trigger self-shut down
The device can be programmable for disaster recovery or other emergencies (e.g.: A boiler can be automatically shut down if temperature exceeds a threshold—without intervention from a separate control system.

Optionally, the system 10 may include a communication component 22 (such as a universal bus or equivalent) to which the COMPONENTS 14-20 are connected. Optionally, the COMPONENTS 14-20 may have individual interconnections, in addition to, or instead of, the communication component 22 (depending on it, and how, the system 10 was previously partitioned).

In one embodiment of the present invention, the system 10 may be connected to one or more other local task performance system(s) 24, and/or to one or more remote task performance systems 28 via respective communication links 26 and/or 30. In accordance with the present invention, one or more of the criteria that triggers modification of the system 10 by the ATPM system 12, may be related to or otherwise linked to one or more of the systems 24 and/or 28.

Referring now to FIG. 2, preferably, the ATPM system 12 operates in accordance with a system modification protocol (SM_PROTOCOL) 60, which may be, in whole or in part.
predefined during design or revision of the system 10,
modified from a previous version by the ATPM system 12,
generated dynamically during operation of the system 10, and/or
provided to the ATPM system 12 by one or more personnel authorized to work with the system 10,

Preferably, the SM_PROTOCOL 60 includes the information necessary for the ATPM system 12 to determine the extent of possible modifications that may be applied to the system 10, as well as various options for applying different types of modifications (for example based on lists of FUNCT_CPB, DSGN_FUNCTION(S), and/or ADD_FUNCTION(S) of various system 10 COMPONENTS). The SM_PROTOCOL 60 also includes at least one system modification criteria (SM_CRITERIA) that, if met, triggers the ATPM system 12 to make the necessary modifications to one or more COMPONENTS of the system 10 to cause the desired changes in the system 10. Optionally, the SM_CRITERIA may include different criteria and/or criteria sets for triggering different system 10 modifications. Alternately SM_CRITERIA may include voluntary actions on the part of authorized personnel to enable manual or (otherwise controlled) modification of the system 10.

The SM_PROTOCOL 60 may include one or more of the following optional information items in various embodiments of the present invention:
SR_CRITERIA—similar to the SM_CRITERIA, but when met trigger the ATPM system 12 to return the system 10 to its previous state (or to modify it further)
Additional Data—any other data that may be useful to the ATPM system 12 and/or to the system 10 supervisor in making decisions regarding system 10 modification and the specific approach in doing so.
TPS_PART_DATA—data regarding the current system 10 partitions, inter-partition links, information about all COMPONENTS (may be present if the system 10 has been previously partitioned using the advantageous technique disclosed in the Model Partition Application,); and
RD_CAPACITY—redundant capacity of one or more system 10 COMPONENTS that may be available to the ATPM system 12 during system 10 modification.

As shown above, the quality, accuracy, and detail level of the available SM_PROTOCOL 60 is proportional to the ability, speed, and efficiency with which the ATPM system 12 can make the necessary modifications to the system 10, when one or more of the SM_CRITERIA is met, while it is not necessary for the system 10 to have been previously partitioned in order to be modified by the ATPM system 12: it is advantageous to utilize partitioning techniques (whether automatic, semi-automatic, or manual) to facilitate the modification process. In addition, utilization of partitioning techniques facilitates implementation of the HAL approach to system design, configuration and programming.

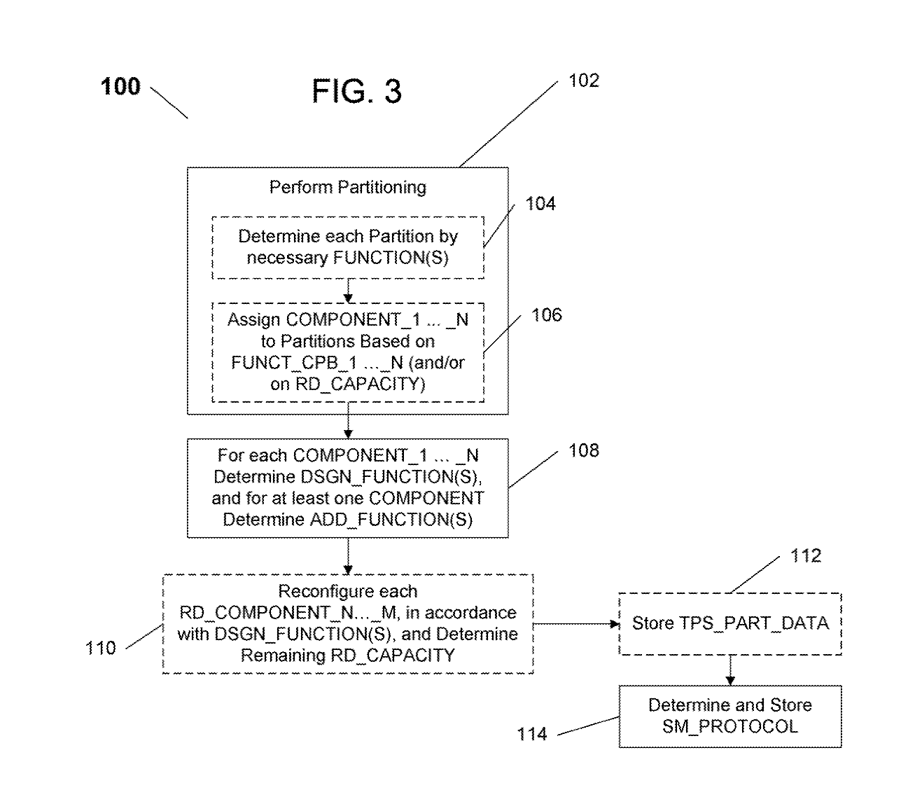

While an advantageous partitioning technique has been shown in great detail in the Model Partition Application, referring now to FIG. 3, an exemplary process 100 for preparing the system 10 for rapid and efficient modification (that may take place at some later time), or that may be used by the ATPM system 12 during system 10 modification, is shown as a novel continuation of virtually any partitioning process. The process 100 begins at a step 102, where the system 10 is partitioned (for example from a visual designed system 10 model) for example by use of the novel primary/secondary partitioning techniques disclosed in the Model Partition Application, or alternately by use of any other automatic, semi-automatic, or manual partitioning technique, as long as such technique is capable of logically assigning necessary system 10 functionality to appropriate system 10 COMPONENTS, as well as retaining information about the COMPONENT(s)′ characteristics.

By way of example, an alternate embodiment of the partitioning step 102 may include a step 104 of determining (automatically or manually) various partitions in the system 10 by the necessary FUNCTION(S) for each partition (that in total make up the intended functionality of the system 10), and then at a step 106, assigning one or more of COMPONENT_1 . . . _N to each partition based on their respective FUNCT_CPB (and/or optionally on their RD_CAPACITY).

At a step 108, for each COMPONENT_1 . . . _N, one or more DSGN_FUNCTION(S) are determined (optionally skipping redundant COMPONENT(S) if any), and for at least one of the COMPONENT(S)_1 . . . -N: ADD_FUNCTION(S) may be determined to facilitate later operation of the ATPM system 12. If the process 100 is being performed by the ATPM system 12 during system 10 modification, an optional step 110 may be performed if one or more redundant components RD_COMPONENT_N . . . _M are available, in which case, each RD-COMPONENT is reconfigured in accordance with one or more DSGN_FUNCT(S), specific to the system 10 modification process, and remaining RD_CAPACITY optionally determined for recording in the SM_PROTOCOL 60, for possible future reference by the ATPM system 12.

At an optional step 112, the TPS_PART_DATA, representative of the newly partitioned system 10 may be stored (for example in the SM_PROTOCOL 60) for possible future reference by the ATPM system 12.

At a step 114, the SM_PROTOCOL is determined and stored (either in its initial form if the process 100 is the first partitioning process of the system 10, or updated/otherwise modified during later iterations of the process 100.

It should be noted that the ATPM system 12 may readily modify the operation of the system 10 in other ways. For example, the SM_CRITERIA may actually be the addition of a new COMPONENT (or COMPONENTS) to the system 10, rather than some external event. If one or more of the above-described smart-device-based COMPONENTS is utilized, especially in conjunction with the communication element 22 implemented as a universal network interface (UNI), or a component framework, the process of system 10 modification can flow virtually automatically. For example, if a component framework configuration is used for the element 22, if a COMPONENT is pre-installed, the framework 22 automatically detects the presence and capabilities of all COMPONENTS. Communication between COMPONENTS may be readily handled via messaging or equivalent. Other advantages of this approach include, but are not limited to the following:
COMPONENTS may be installed off a palette of devices
“Wizards” or other automated guides can help users in selecting COMPONENTS for addition to the system 10 based on required modified system 10 specs
COMPONENTS identify themselves
COMPONENTS present their EDS to the framework 22
Framework 22 presents choice of data to user (for configuration) based on what is available from each COMPONENT
Presented data may includes calibration data supplied by the COMPONENT

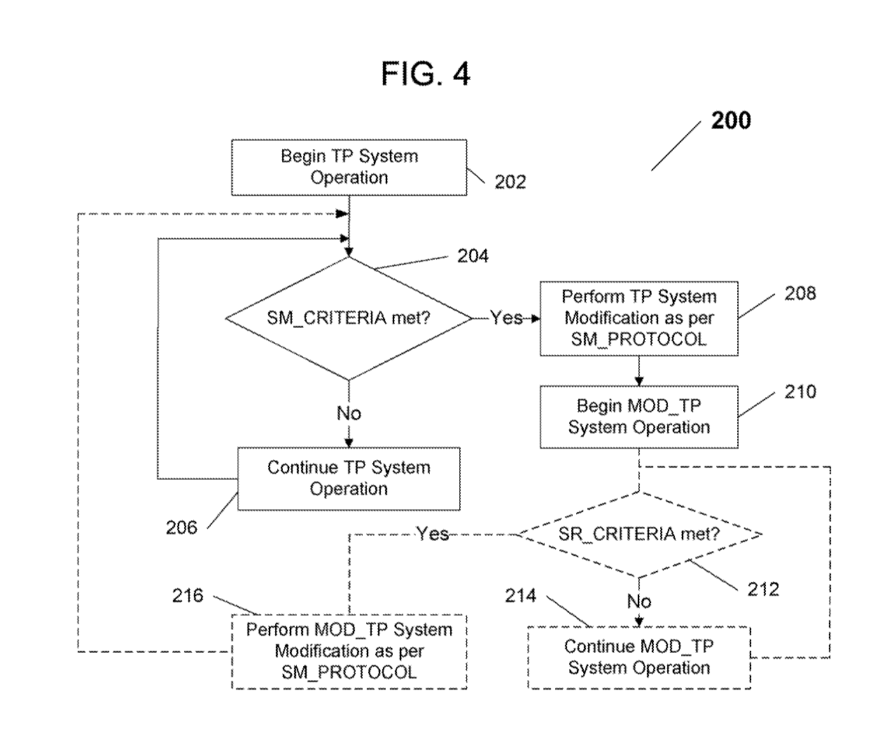

Referring now to FIG. 4, an exemplary embodiment of a novel process of operation of the ATPM system 12 is shown as a process 200. At a step 202, the system 10 (TP system) begins operation. During system 10 operation, a test 204 determines whether at least one SM_CRITERIA is met (this determination may be reached through passive or active monitoring, as a matter of design choice). As long as none of the SM_CRITERIA is met, the system 10 continues operation at a step 206. However, if at some point, any of the SM_CRITERIA is met, at a step 208, the ATPM system 12 performs modification of the system 10 in accordance with the SM_PROTOCOL. As noted above, this may be accomplished in a variety of ways, but preferably by modifying the system 10 partition in case of small modifications, or repartitioning the system 10, in case of more in-depth modifications (for example as shown in the process 100 of FIG. 3). The modified system 10 then continues operation at a step 210.

In an alternate embodiment of the invention, the process 200 may include additional steps for optionally returning the system 10 to its previous state, or for imposing further modification on the modified system 10. In this case, an optional test 212 determines if during modified system 10 operation any of the SR_CRITERIA is met. If not, at an optional step 214, the modified system 10 continues operation. Otherwise, at a step 216, the modified system 10 is either returned to its previous state or further modified, in accordance with the SM_PROTOCOL and then either continues operation, ends or returns to the test 204.

The above described novel ATPM system 12 can be advantageously implemented in a virtually unlimited variety of real-world applications.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto,

We claim:

1. A data processing system for changing functionality of a task performance system having a plurality of components, each operable to perform at least one function, from a first functionality to a second functionality, when at least one predetermined criteria is met, the system comprising,
monitoring means for determining when said at least one criteria is met; and
reconfiguration means, responsive to said monitoring means, for changing the at least one function of at least one of the plural components, in accordance with at least one met criteria: such that the task performance system functionality changes from the first functionality to the second functionality.

2. The data processing system of claim 1, wherein said reconfiguration means operates in at least one of the following modes: automatically, semi-automatically, or manually.

3. The data processing system of claim 1, wherein at least one of the plural components is operable to perform at least one additional function, and wherein said reconfiguration means comprises activation means for activating at least a portion of said at least one additional function.

4. A task performance system capable of selectively changing a functionality thereof from a first functionality to a second functionality, comprising:
a plurality of components, each operable to perform at least one function:
modification means, for selectively changing the at least one function of at east one of the plural components, sufficient to change the task performance system functionality from the first functionality to the second functionality;
trigger means for triggering said modification means in response to a predetermined trigger condition.

5. The task performance system of claim 4, wherein said trigger condition comprises at least one predetermined criteria.

6. A data processing method for changing functionality of a task performance system having a plurality of components, each operable to perform at least one function, from a first functionality to a second functionality, in response to at least one criteria, comprising the steps of;
(a) determining when at least one criteria is met; and
(b) changing the at least one function of at least one of the plural components, in accordance with at least one met criteria, such that the task performance system functionality changes from the first functionality to the second functionality.

7. A method for enabling a task performance system, having a plurality of components, each operable to perform at least one function, to selectively change a functionality thereof from a first functionality to a second functionality, comprising the steps of:
(a) issuing a system modification command to change the task performance system functionality from the first functionality to the second functionality in response to a predetermined trigger condition; and
(b) in response to said system modification command, selectively changing the at least one function of at least one of the plural components, sufficient to change the task performance system functionality from the first functionality to the second functionality,

8. The method of claim 7, further comprising the step of:
(c) prior to said step (a), partitioning the task performance system in accordance with a partitioning protocol and the at least one function of each plural component, to provide the task performance system with the first functionality.

9. The method of claim 8, wherein, said step (b) comprises the step of:
(d) re-partitioning the task performance system to change the functionality of the task performance system from the first functionality to the second functionality.
